(19) United States
(12) Patent Application Publication
(10) Pub. No.: US 2023/0177976 A1
(43) Pub. Date: Jun. 8, 2023

(54) Commercial Vehicle Back-Up Trainer and Method

(71) Applicant: J.J. Keller & Associates, Inc., Neehan, WI (US)

(72) Inventors: Jason Jon Kreidler, Sheboygan, WI (US); Ryan N. Gens, Neenah, WI (US); Benjamin Luke Burleson, College Station, TX (US)

(21) Appl. No.: 17/545,637

(22) Filed: Dec. 8, 2021

(51) Int. Cl. G09B 19/16; G09B 19/00; B62D 13/06

(52) U.S. Cl. CPC G09B 19/167; G09B 19/003; G09B 19/0007; B62D 13/06; G05D 2201/0213

(57) ABSTRACT

A commercial vehicle backup trainer and method for enabling drivers to practice backing up and to provide the drivers with real-time feedback during backup training.

### FIELD OF THE INVENTION

The present subject matter relates to a commercial vehicle backup trainer and method of use by drivers to practice backing up with real time feedback.

### BACKGROUND OF THE INVENTION

Backup exercises are an integral part commercial driver training, but there are no assistive devices that are currently used to provide real-time driver feedback during training. There is no commercially-available product designed to give real time feedback during commercial vehicle backing exercises.

### SUMMARY OF THE INVENTION

In one construction, the disclosure provides a commercial vehicle backup trainer comprising a distance sensor for measuring the distance between the rear of a commercial vehicle and a fixed training target while a driver is practicing backing up the commercial vehicle and a visual indicator viewable by the driver of the commercial vehicle that changes color as the distance between the commercial vehicle and the training target changes as the driver is practicing backing up towards the training target.

In another construction, the disclosure provides a commercial vehicle backup trainer comprising a distance sensor, color changeable lights, a display screen a processor in communication with the distance sensor, the color changeable lights and the display screen and a support structure for supporting the distance sensor, the color changeable lights, the display screen and the processor, wherein the distance sensor continually measures the distance between the rear of a commercial vehicle that is being backed up toward the support structure and continually communicates that distance to the processor, wherein the processor continually communicates the distance to the display screen for viewing by the commercial vehicle's driver, and wherein the processor changes the color changeable lights for viewing by the commercial vehicle's driver as the distance of the commercial vehicle to the support structure decreases as the commercial vehicle is being backed up toward the support structure.

In another construction, the disclosure provides a method for a driver to practice backing up a commercial vehicle toward a fixed training target while being provided real time feedback in a first mode, the method comprising the steps of providing a fixed training target for a driver of a commercial vehicle to practice backing up toward, continuously measuring the distance between the rear of the commercial vehicle and the fixed training target while the driver is practicing backing up the commercial vehicle and providing real-time visual feedback to the driver as the distance between the rear of the commercial vehicle and the fixed training target changes using color changeable lights.

In another constructions, the disclosure provides a method for a driver to practice backing up a commercial vehicle toward a fixed training target while being provided real time feedback comprising the steps of providing a fixed training target for a driver of a commercial vehicle to practice backing up toward, continuously measuring the distance between the rear of the commercial vehicle and the fixed training target while the driver is practicing backing up the commercial vehicle, and providing real-time feedback to the driver of the distance between the rear of the commercial vehicle and the fixed training target and of the skew angle of the commercial vehicle relative to the fixed training target.

Other aspects of the disclosure will become apparent by consideration of the detailed description and accompanying drawings.

### BRIEF DESCRIPTION OF THE DRAWINGS

FIG. 1 is a front view of a commercial vehicle backup trainer.

FIG. 2 is a perspective view of the commercial vehicle backup trainer and commercial vehicle.

FIG. 3 is a schematic view of a controller.

FIG. 4 is a flow chart of a method of use of the commercial vehicle backup trainer in a training mode.

FIG. 5 is a flow chart of a method of use of the commercial vehicle backup trainer in a practice mode.

FIG. 6 is second embodiment of a commercial vehicle backup trainer.

FIG. 7 is a third embodiment of a commercial vehicle backup trainer.

FIG. 8 is a data display of the third embodiment of the commercial vehicle backup trainer.

FIG. 9 is a data display of the third embodiment of the commercial vehicle backup trainer.

FIG. 10 is a data display of the third embodiment of the commercial vehicle backup trainer.

FIG. 11 is a fourth embodiment of the commercial vehicle backup trainer.

### DETAILED DESCRIPTION

Before any constructions of the disclosure are explained in detail, it is to be understood that the disclosure is not limited in its application to the details of construction and the arrangement of components set forth in the following description or illustrated in the following drawings. The disclosure is capable of other constructions and of being practiced or of being carried out in various ways.

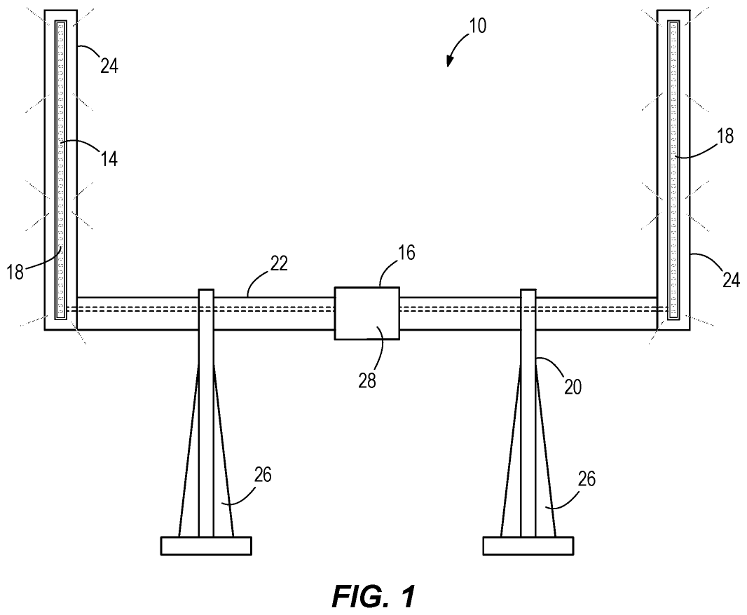

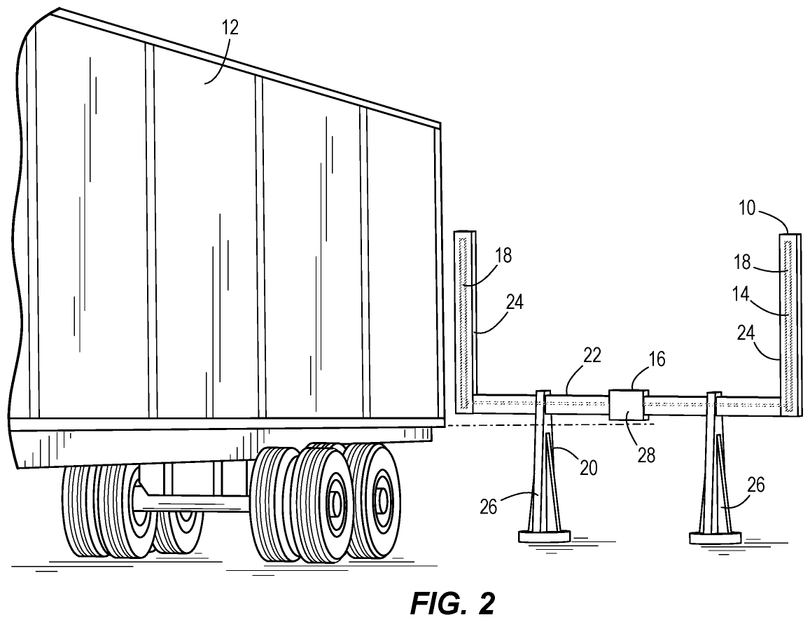

FIGS. 1 and 2 illustrate a commercial vehicle backup trainer 10 according to one embodiment of the invention. The backup trainer 10 provides a fixed training target for a driver to back up a commercial vehicle 12 toward to practice back up skills and improve proficiency. Commercial vehicles 12 can include all types of commercial vehicles such as semi-trailer trucks, box trucks, passenger buses, and heavy machinery. The backup trainer 10 uses a visual indicator 14 as real-time feedback to notify the driver of the distance between the back of the commercial vehicle 12 and the fixed training target. This allows the driver to easily gauge and learn to perceive the space occupied by the commercial vehicle 12 while backing up. Through the use of the backup trainer 10, commercial vehicle drivers will more quickly learn how to back up a precise or predetermined distance to a target location.

The backup trainer 10 includes a distance sensor 16 that measures the distance between the rear of the commercial vehicle 12 and the fixed training target. For example, the distance sensor 16 can includes a LIDAR type of sensor available from Benewake as model TFmini-i. It should be noted, however, that other types of distance sensors can also be utilized.

The visual indicator 14 for the driver in this embodiment is used as a real-time status indicator during a driver's backup attempt while practicing. The visual indicator 14 preferably includes color changeable, individually addressable lights such as strips 18 of LEDs. Color changeable or changes in color with respect to lights includes different colors, different intensities of the same color or variable lighting such as blinking, strobing or solid. For example, visual indictor 14 can include individually addressable type LEDs available from Bright LED Electronics Corp as model BB-HJXGABG32K-TRB in a strip configuration 18. It should be noted that other types of LEDS, LED configurations and visual indicators can be utilized such as other types of lights, neon lights, LCD displays and the like.

As shown in FIGS. 1 and 2, the backup trainer 10 in this embodiment includes a structure 20 that is assembled at a training facility or location and positioned near the rear of the commercial vehicle 12. As an example, the structure 20 may include a crossbeam 22, an upright 24 on each end of the crossbeam 22, and two posts 26 supporting the crossbeam 22. It should be noted that other structures can be utilized such as a traffic barricade, sawhorse structure and the like. The structure 20 acts as the fixed training target for the driver while practicing backing up. The visual indicator 14 for the driver is preferably located on each upright 24 so as to be viewable by the driver in the commercial vehicle mirrors.

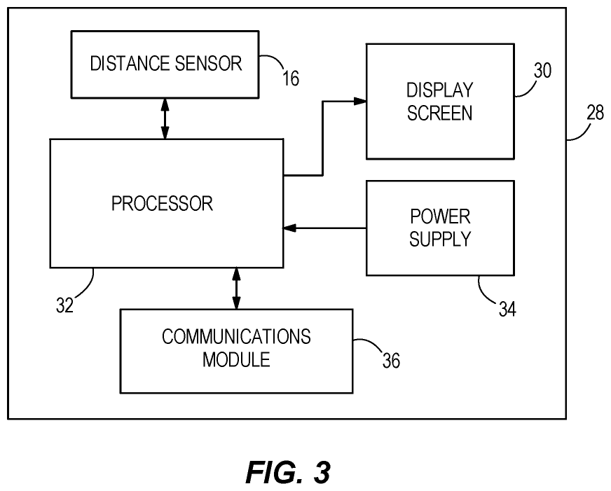

A controller 28 is mounted to the crossbeam 22, such as in the center of the crossbeam 22 between the uprights 24. As shown in FIG. 3, the controller 28 includes the distance sensor 16 as well as a display screen 30, a processor 32, a power supply 34 and a communications module 36, as are known in the art. The controller 28 is in wired or wireless communication with the distance sensor 16, the display screen 30 and the visual indictor 14 as is known in the art. The processor 32 receives the distance inputs from the distance sensor 16 and communicates with the visual indicator 14 based upon the distance measured to provide real-time feedback to the driver. The processor 32 receives the distance inputs from the distance sensor 16 and communicates with the display screen 30 to display the current numerical distance.

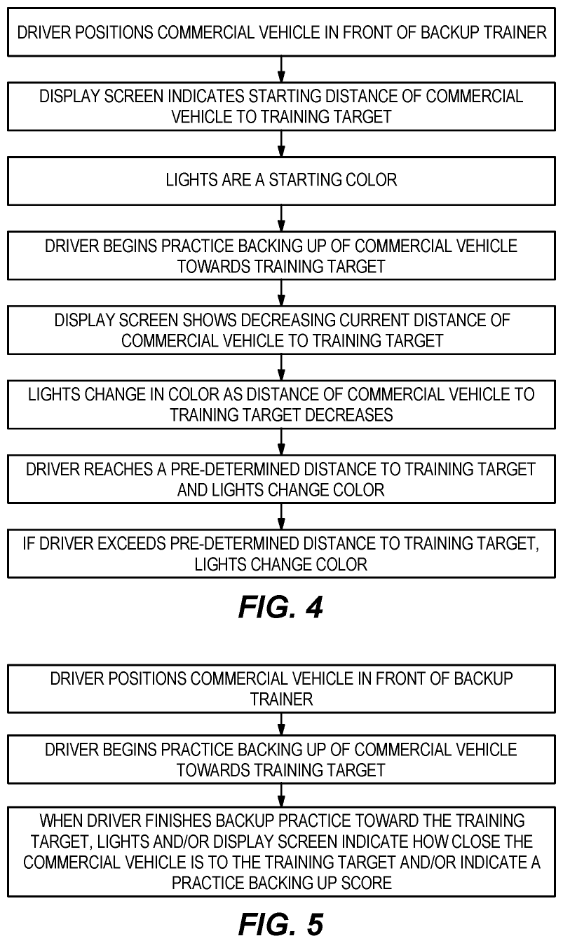

In operation in a training or first mode and with reference to FIG. 4, a driver positions the commercial vehicle 12 in front of the structure 20. The display screen 30 visually indicates the distance between the rear of the commercial vehicle 12 and the structure 20 as a starting point. The visual indicator 14 is in a first color as a starting point. The driver then starts to back up the commercial vehicle 12 with the goal of ending up a predetermined distance from the structure 20 which is acting as the fixed training target. As the commercial vehicle 12 progresses toward the fixed training target decreasing its distance to the fixed training target, the distance sensor 16 measures that distances and continually communicates that distance to the processor 32. The processor 32 continually communicates the distance to the display screen 30 which displays the current distance as real-time feedback for the driver so that, while practicing, the driver can learn to gauge a distance to a target and learn to perceive distances while backing up a commercial vehicle 12.

As the commercial vehicle 12 progresses toward the fixed training target decreasing the distance to the fixed training target, the visual indicator 14 changes colors. For example, the starting point can be a flashing green light, then as the distance decreases as the commercial vehicle 12 is closer to the fixed training target, the visual indicator changes to solid green and then progressively changes to solid yellow and then solid red. When the driver reaches a predetermined set distance from the fixed training target, the visual indicator 14 changes from solid red to flashing red to caution the driver to stop backing up. It should be noted that other colors, combinations of colors, intensity or blinking can be utilized to provide visual feedback to the driver as they near the fixed training target while practicing back up the commercial vehicle 12.

While using the backup trainer 10, the driver is provided with real-time feedback while in the process of practicing backing up. The real-time feedback can include the numerical distance from the commercial vehicle 12 to the fixed training target and/or the color changeable lights.

Further, the real-time feedback may include a skew angle of the commercial vehicle 12 relative to the fixed training target during or after the backup attempt. To determine a skew angle, the backup trainer 10 measures the angle at which the commercial truck 12 is backing up in relation to the fixed training target. In an optimal backup attempt, the rear of the commercial vehicle 12 should be parallel with the fixed training target when the commercial vehicle 12 comes to a stop. An example of two methods of determining the skew angle are as follows, however, it should be noted that other methods known to those of skill in the art can also be utilized. In a first example, a second distance sensor (not shown) is placed at a known angle to the distance sensor 16. The sensor pair determines how far the commercial vehicle angle deviates from the ideal parallel position using the distance measured by the distance sensor 16, which measures the distance to the back of the commercial vehicle 12 and the distance measured by the second sensor, which measures the distance to the back of the commercial vehicle 12 at the known angle from the distance sensor 16. Using the two distances and the known angle, the processor 32 can then determine the skew angle. In a second method for determining the skew angle, the two distance sensors both measure distance perpendicular to the fixed training target but are spaced a known distance apart from each other. Using this known distance, the distance measured by the distance sensor 16 and the distance measured by the second sensor, the processor 32 can determine the skew angle. The skew angle measured either during or after the backup attempt is communicated to the driver using the visual indicator 14 or using the display screen 30.

With reference to FIG. 5, the backup trainer 10 can be used in a second or practice mode. The driver positions the commercial vehicle 12 in front of the backup trainer 10 and begins to back up the commercial vehicle 12 toward the structure 20, acting as the fixed training target, without any feedback from the visual indicator 14 and/or display screen 30. Once the backup has been executed and the commercial vehicle 12 has come to a stop, the visual indicator 14 and/or display screen 30 may indicate a score to the driver and/or indicate how close the stopped position is to the predetermined distance. For example, the score can be based upon how close in distance to the fixed training target the driver stopped the commercial vehicle 12 and/or the final skew angle of the commercial vehicle 12 relative to the training target. It should be noted that other criteria or combinations of criteria can also be utilized to score the backup effort. The score can be communicated to the driver using the visual indicator 14 such as by changing the lights, using a specific color for a given score or flashing a specific color sequence. The score can also be communicated to the driver via the display screen 30, via an auditory signal or any other methods.

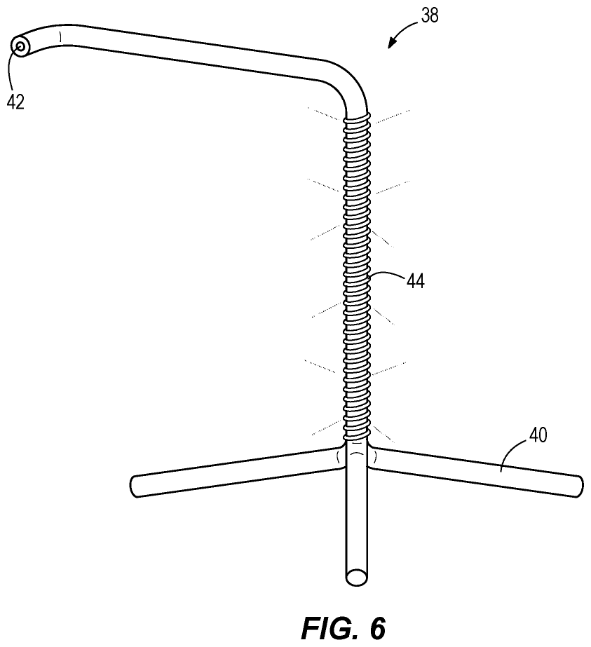

Turning now to FIG. 6 and a second embodiment of a backup trainer 38, there is shown a structure 40 including a distance sensor 42 in communication with a visual indicator 44 such as the strip of LEDs shown. One or more of these structures 40 can be utilized to provide real-time feedback to a commercial vehicle driver while the driver is practicing backing up. In operation, the distance sensor 42 measures the distance between the rear of the commercial vehicle 12 and the structure 40 and communicates that to the visual indicator 44 to change color based up the distance measured.

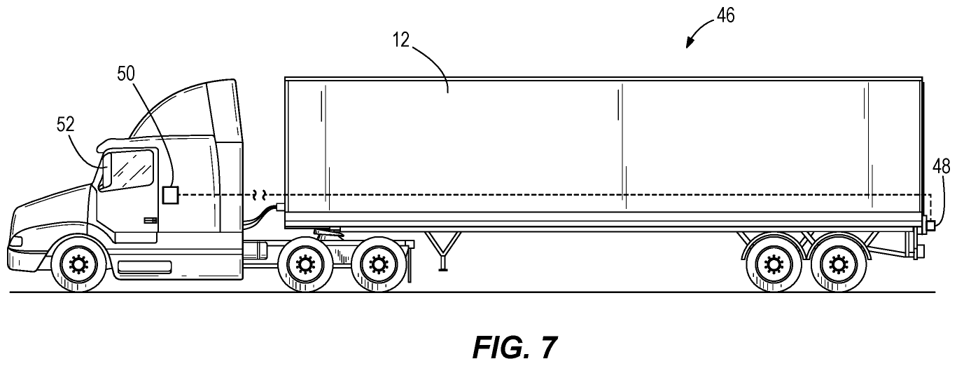

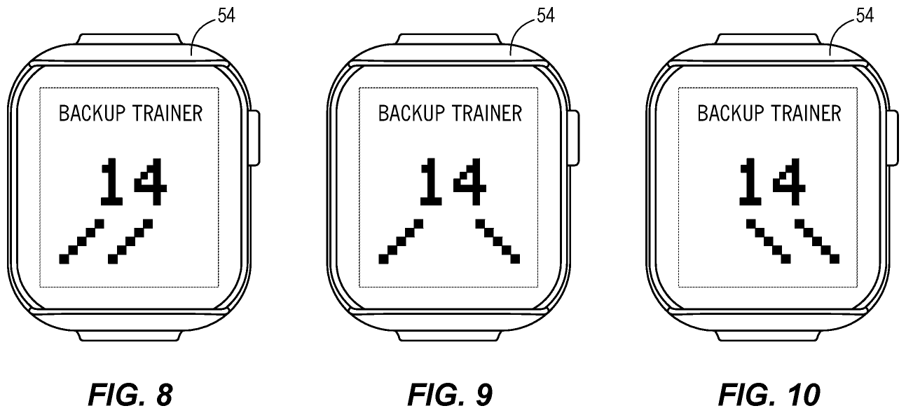

Turning now to FIG. 7 and a third embodiment of the backup trainer 46, a distance sensor 48 is mounted to the rear of the commercial vehicle 12. A display screen 50 is located in the cab 52 of the commercial vehicle 12 for viewing by the driver during the backup training toward a fixed training target (not shown). The display screen 50 can include a video screen or a screen such as on a mobile phone, laptop, smartwatch and the like, however, other display screens can also be utilized. See for example FIGS. 8-10 showing various displays on a smart watch 54 acting as the display screen wherein the distance in shown in numeric form (for example 14) and also optionally shows the skew angle of the commercial vehicle 12 as it is backing up or after it has stopped backing up. For example, a left skew angle is shown in FIG. 8, no skew angle is shown in FIG. 9 and a right skew angle is shown in FIG. 10. It should also be noted that color changeable visual indicator can be represented on the display screen 50 as well showing the progress toward the fixed training target.

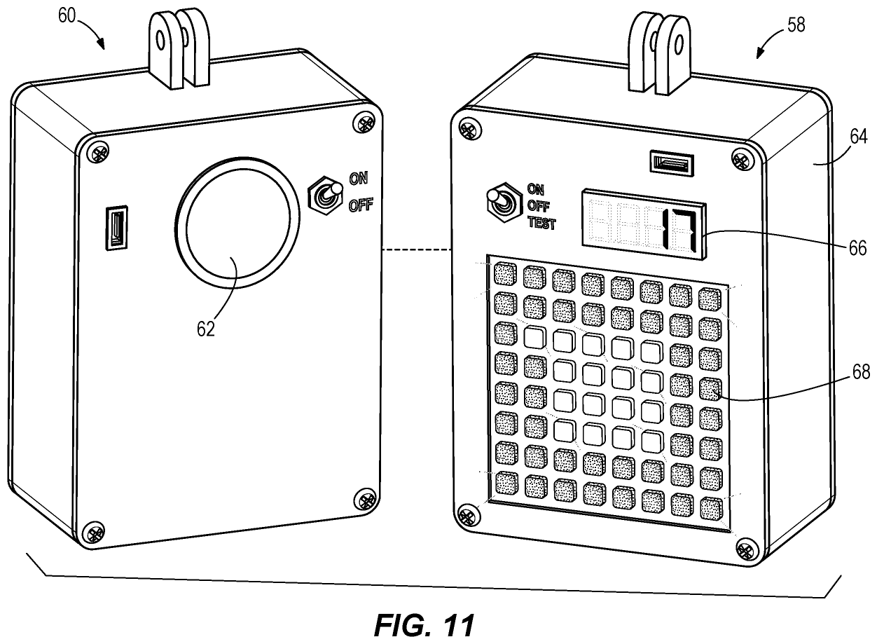

Turning now FIG. 11 and a fourth embodiment of a backup trainer 58, a box 60 includes a distance sensor 62 and is mounted to the rear of the commercial vehicle 12 and a box 64 is a display that is positioned in the cab of the commercial vehicle 12 for displaying real-time feedback for the driver while practicing backing up. The box 64 includes one or both of a display 66 of the numerical distance and color changeable lights 68. The boxes 60 and 64 wirelessly communicates with each other.

In any of the embodiments of the backup trainer described above, sound can also be utilized as feedback for the driver during backup practice. For example, speakers can be located outside of or inside the commercial vehicle cab to provide a beeping tone that changes in tone, frequency and/or volume as the commercial vehicle gets closer to training target. It should be noted that other audio feedback for the driver can also be utilized.

Various features and advantages of the invention are set forth in the following claims.

What is claimed is:

1. A commercial vehicle backup trainer comprising:
a distance sensor for measuring the distance between the rear of a commercial vehicle and a fixed training target while a driver is practicing backing up the commercial vehicle; and
a visual indicator viewable by the driver of the commercial vehicle that changes color as the distance between the commercial vehicle and the training target changes as the driver is practicing backing up towards the training target.

2. The commercial vehicle backup trainer of claim 1 wherein the visual indicator includes color changeable lights.

3. The commercial vehicle backup trainer of claim 1 wherein the visual indicator is a display screen.

4. The commercial vehicle backup trainer of claim 1 wherein the distance sensor is adjacent the training target.

5. The commercial vehicle backup trainer of claim 1 wherein the distance sensor is mounted on the commercial vehicle.

6. The commercial vehicle backup trainer of claim 1 and further including a display screen for indicating the numerical distance between the rear of the commercial vehicle and the fixed training target.

7. The commercial vehicle backup trainer of claim 6 wherein the display screen indicates a score obtained by the driver for a backup attempt.

8. The commercial vehicle backup trainer of claim 6 wherein the display screen is part of one of a mobile computer, a mobile smart device and a smart watch.

9. The commercial vehicle backup trainer of claim 1 and further including a display screen.

10. The commercial vehicle backup trainer of claim 1 and further including a structure for supporting the distance sensor and the visual indicator, the structure acting as the fixed training target.

11. The commercial vehicle training backup trainer of claim 1 wherein the distance sensor is mounted to the commercial vehicle and the visual indicator is viewable by the driver while in the commercial vehicle.

12. A commercial vehicle backup trainer comprising:
a distance sensor;
color changeable lights;
a display screen;
a processor in communication with the distance sensor, the color changeable lights and the display screen; and
a support structure for supporting the distance sensor, the color changeable lights, the display screen and the processor;
wherein the distance sensor continually measures the distance between the rear of a commercial vehicle that is being backed up toward the support structure and continually communicates that distance to the processor,
wherein the processor continually communicates the distance to the display screen for viewing by the commercial vehicle's driver, and
wherein the processor changes the color changeable lights for viewing by the commercial vehicle's driver as the distance of the commercial vehicle to the support structure decreases as the commercial vehicle is being backed up toward the support structure.

13. The commercial vehicle backup trainer of claim 10 wherein the color changeable lights are mounted on at least one strip.

14. The commercial vehicle backup trainer of claim 10 wherein the color changeable lights includes LEDs.

15. The commercial vehicle backup trainer of claim 10 wherein the support structure includes at least one upright, a cross beam and at least one post.

16. The commercial vehicle backup trainer of claim 10 wherein the support structure is moveable to various locations.

17. The commercial vehicle backup trainer of claim 10 wherein the color changeable lights includes a solid color mode and a blinking mode.

18. The commercial vehicle backup trainer of claim 10 wherein the distance sensor, display screen and controller are mounted in a housing.

19. A method for a driver to practice backing up a commercial vehicle toward a fixed training target while being provided real time feedback in a first mode, the method comprising the steps:
providing a fixed training target for a driver of a commercial vehicle to practice backing up toward;
continuously measuring the distance between the rear of the commercial vehicle and the fixed training target while the driver is practicing backing up the commercial vehicle; and
providing real-time visual feedback to the driver as the distance between the rear of the commercial vehicle and the fixed training target changes using color changeable lights.

20. The method of claim 19 wherein the real-time visual feedback further includes displaying the decreasing numerical distance to the fixed training target.

21. The method of claim 19 wherein the real-time visual feedback includes changing the color of multicolored lights as the distance between the rear of the commercial vehicle and the fixed training target decreases.

22. The method of claim 19 and further including the step of providing the driver a score based upon the accuracy of a backup practice attempt.

23. The method of claim 19 and further including a second mode wherein the real-time visual feedback is not provide to the driver during a backup practice attempt, wherein after the practice attempt has concluded and the vehicle has stopped moving, the driver is provided with a visual indication of the commercial vehicle distance to the fixed training target.

24. The method of claim 19 and further including providing skew angle data of the commercial vehicle relative to the fixed training target.

25. The method of claim 19 and further including providing changing audio feedback as the distance between the rear of the commercial vehicle and the fixed training target changes.

26. A method for a driver to practice backing up a commercial vehicle toward a fixed training target while being provided real time feedback, the method comprising the steps:
providing a fixed training target for a driver of a commercial vehicle to practice backing up toward;
continuously measuring the distance between the rear of the commercial vehicle and the fixed training target while the driver is practicing backing up the commercial vehicle; and
providing real-time feedback to the driver of the distance between the rear of the commercial vehicle and the fixed training target and of the skew angle of the commercial vehicle relative to the fixed training target.
